(19) United States
(12) Patent Application Publication
(10) Pub. No.: US 2005/0255370 A1
(43) Pub. Date: Nov. 17, 2005

(54) Vapor deposited catalysts and their use in fuel cells

(76) Inventors: Juan C. Figueroa, Wilmington, DE (US); Cynthia A. Lundgren, Rising Sun, MD (US)

Correspondence Address: Thomas W Gorman;E I Du Pont De Nemours & Company, Legal Patent Records Center, 4417 Lancaster Pike, Wilmington, DE, 19805, US

(21) Appl. No.: 10/518,330

(22) PCT Filed: Jun. 30, 2003
(86) PCT No.: PCT/US03/20893

§ 371 Date: Dec. 15, 2004

Related U.S. Application Data
(60) Provisional application No. 60/393,351, filed on Jul. 1, 2002.

(51) Int. Cl. H01M 4/90; H01M 4/94; H01M 4/96; B01J 31/00; B01J 21/18

(52) U.S. Cl. 429/40; 429/44; 429/42; 502/4; 502/159; 502/185

(57) ABSTRACT

The invention provides a catalyst useful in a proton exchange membrane containing fuel cell for the electrooxidation of fuels prepared by the chemical activation of vapor deposited substantially semicrystalline PtXaAlb onto a substrate, wherein X is selected from the group consisting of Ru, Rh, Mo, W, V, Hf, Zr, Nb and Co, and a is at least 0.001, and b is at least 0.85·(1+a), with the proviso that when a=1 and b=8, X is only selected from the group consisting of W, V, Hf, Zr, Nb, and Co. These catalysts have an onset voltage for the electrooxidation of methanol of less than about 240 mV versus a saturated calomel electrode (SCE). They are useful in making diffusion backing electrodes and catalyst coated membranes for use in fuel cells.

### FIELD OF INVENTION

This invention relates to vapor deposited catalysts and their use in fuel cells. It further relates to Catalyst Coated Membranes (CCMs) and Gas Diffusion Backing Electrodes (GDEs) formed from these catalysts.

### BACKGROUND OF THE INVENTION

Fuel cells are devices that convert fuel and oxidant to electrical energy. Electrochemical cells generally include an anode electrode and a cathode electrode separated by an electrolyte. A well-known use of electrochemical cells is in a stack for a fuel cell that uses a proton exchange membrane (hereafter “PEM”) as the electrolyte. In such a cell, a reactant or reducing fluid such as hydrogen is supplied to the anode electrode and an oxidant such as oxygen or air is supplied to the cathode electrode. The hydrogen electrochemically reacts at a surface of the anode electrode to produce hydrogen ions and electrons. The electrons are conducted to an external load circuit and then returned to the cathode electrode, while hydrogen ions transfer through the electrolyte to the cathode electrode, where they react with the oxidant and electrons to produce water and release thermal energy.

Most efficient fuel cells use pure hydrogen as the fuel and oxygen as the oxidant. Unfortunately, use of pure hydrogen has a number of know disadvantages, not the least of which is the relatively high cost, and storage considerations. Consequently, attempts have been made to operate fuel cells using other than pure hydrogen as the fuel.

For example, attempts have been made to use hydrogen-rich gas mixtures obtained from steam reforming methanol as a fuel cell feed. This may be particularly important for automotive applications, since a convenient source of hydrogen gas can be the steam reformation of methanol, since methanol can be stored more easily in a vehicle than hydrogen. Also, attempts have been made to use methanol as a direct fuel cell feed, because this eliminates the need for a reformer.

A need exists for fuel cell anode catalysts that are capable of reducing the onset voltage for the electrooxidation of hydrogen in the presence of CO or for the electrooxidation of methanol.

### SUMMARY OF THE INVENTION

In a first aspect, this invention provides a catalyst useful in a proton exchange membrane containing fuel cell for the electrooxidation of fuels prepared by the chemical activation of vapor deposited substantially semicrystalline PtXₐAl_{b} onto a substrate, wherein X is selected from the group consisting of Ru, Rh, Mo, W, V, Hf, Zr, Nb and Co, and a is at least 0.001, and b is at least 0.85·(1+a) (· is a symbol denoting the multiplication between 0.85 and (1+a), with the proviso that when a=1 and b=8, X is only selected from the group consisting of W, V, Hf, Zr, Nb, and Co.

In a second aspect, the invention provides a catalyst for an ion exchange membrane containing fuel cell comprising a ternary composition having an onset voltage for the electrooxidation of methanol of less than about 240 mV versus a saturated calomel electrode (SCE).

In a third aspect, the invention provides a coated substrate comprising a substrate having applied thereon an catalyst composition, wherein the catalyst composition comprises a catalyst for the electrooxidation of fuels prepared by the chemical activation of vapor deposited substantially semicrystalline
PtXₐAl_{b}
wherein X is selected from the group consisting of Ru, W, V, Hf, Rh, Zr, Mo, Nb and Co, and
a is at least 0.001, and b is at least 0.85·(1+a); with the proviso that when a=1 and b=8, X is only selected from the group consisting of W, V, Hf, Zr, Nb, and Co.

In a fourth aspect, the invention provides a fuel cell comprising a coated substrate, wherein the coated substrate comprises a substrate having thereon a catalyst composition, wherein the catalyst composition comprises a catalyst for the electrooxidation of fuels prepared by the chemical activation of vapor deposited substantially semicrystalline
PtXₐAl_{b}
wherein X is selected from the group consisting of Ru, W, V, Hf, Rh, Zr, Mo, Nb and Co, and
a is at least 0.001, and b is at least 0.85·(1+a); with the proviso that when a=1 and b=8, X is only selected from the group consisting of W, V, Hf, Zr, Nb, and Co.

### DETAILED DESCRIPTION OF THE INVENTION

Definitions:

Onset voltage is defined as the potential, referred to a saturated calumel electrode (SCE), at which current for methanol oxidation commences during linear polarization testing in a 1M CH₃OH/0.5MH₂SO₄ solution at room temperature.
Standard Calomel electrode (SCE) is a Hg electrode in contact with a saturated KCl solution containing Cl⁻ anions that form a sparingly soluble salt Hg₂Cl₂ with the Hg ions. Under these circumstances, the Hg|Hg₂Cl₂|Cl⁻ electrode potential becomes stabilized at 0.268 volts versus a hydrogen electrode (conventionally set at 0 volts).
Semicrystalline is defined as a characteristic of a solid having regions that do not have long range atomic order (amorphous regions) coexisting with others having long range atomic ordering (crystalline regions).
Electrooxidation is defined as an electrochemical process that transforms fuels in a way that electrons and protons are generated.
Chemical activation is defined as the attainment of practical catalytic activity for a given precursor formulation (which has no such activity) upon its exposure to a chemical.
Vapor deposition is defined as a physical phase transformation process by which a gas transforms into a solid layer deposited on the surface of a solid substrate.
   Catalyst:

The catalyst of the invention useful in a proton exchange membrane containing fuel cell for the electrooxidation of fuels is prepared by the chemical activation of vapor deposited substantially semicrystalline PtXₐAl_{b} onto a substrate, more typically a sheet substrate, wherein X is selected from the group consisting of Ru, Rh, Mo, W, V, Hf, Zr, Nb and Co, and a is at least 0.001, and b is at least 0.85·(1+a), with the proviso that when a=1 and b=8, X is only selected from the group consisting of W, V, Hf, Zr, Nb, and Co.

When the fuel is an organic fuel such as methanol, the catalyst is prepared by the chemical activation of vapor deposited substantially semicrystalline PtXₐAl_{b}, wherein X is selected from the group consisting of Ru, Rh, Mo, W, V, Hf, Zr, Nb and Co, and wherein
when X═Ru, a is at least 0.019, and b is at least 3·(1+a),
when X═Rh, a is at least 0.01, and b is at least 0.85·(1+a),
when X═W, a is at least 0.01, and b is at least 2.5·(1+a),
when X═V, a is at least 0.04, and b is at least 2.8·(1+a),
when X═Hf, a is at least 0.019, and b is at least 1.5·(1+a),
when X═Zr, a is at least 0.01, and b is at least 2.3·(1+a),
when X═Nb, a is at least 0.001, and b is at least 2.2·(1+a), and
when X═Co, a is at least 0.03, and b is at least 2.2·(1+a),
   Substrate:

The substrate, typically a sheet substrate, may be a gas diffusion backing or an ion exchange membrane.

Gas Diffusion Backing:

The gas diffusion backing comprises a porous, conductive sheet material such as paper or cloth, made from a woven or non-woven carbon fiber, that is treated to exhibit hydrophilic or hydrophobic behavior, and a gas diffusion layer, typically comprising a film of carbon particles and fluoropolymers such as polythetrafluoroethylene (PTFE).

Ion Exchange Membrane:

The substrate for use in preparing a catalyst coated membrane (CCM) may be a membrane of ion exchange polymers that are typically highly fluorinated ion-exchange polymers. “Highly fluorinated” means that at least 90% of the total number of univalent atoms in the polymer are fluorine atoms. Most typically, the polymer is perfluorinated. It is also typical for use in fuel cells for the polymers to have sulfonate ion exchange groups. The term “sulfonate ion exchange groups” is intended to refer to either sulfonic acid groups or salts of sulfonic acid groups, typically alkali metal or ammonium salts. For applications where the polymer is to be used for proton exchange as in fuel cells, the sulfonic acid form of the polymer is typical. If the polymer is not in sulfonic acid form when used, a post treatment acid exchange step will be required to convert the polymer to acid form prior to use.

Typically, the ion exchange polymer employed comprises a polymer backbone with recurring side chains attached to the backbone with the side chains carrying the ion exchange groups. Possible polymers include homopolymers or copolymers of two or more monomers. Copolymers are typically formed from one monomer which is a nonfunctional monomer and which provides carbon atoms for the polymer backbone. A second monomer provides both carbon atoms for the polymer backbone and also contributes the side chain carrying the cation exchange group or its precursor, e.g., a sulfonyl halide group such a sulfonyl fluoride (—SO₂F), which can be subsequently hydrolyzed to a sulfonate ion exchange group. For example, copolymers of a first fluorinated vinyl monomer together with a second fluorinated vinyl monomer having a sulfonyl fluoride group (—SO₂F) can be used. Possible first monomers include tetrafluoroethylene (TFE), hexafluoropropylene, vinyl fluoride, vinylidine fluoride, trifluoroethylene, chlorotrifluoroethylene, perfluoro(alkyl vinyl ether), and mixtures thereof. Possible second monomers include a variety of fluorinated vinyl ethers with sulfonate ion exchange groups or precursor groups that can provide the desired side chain in the polymer. The first monomer may also have a side chain that does not interfere with the ion exchange function of the sulfonate ion exchange group. Additional monomers can also be incorporated into these polymers if desired.

Typical polymers include a highly fluorinated, most typically a perfluorinated, carbon backbone with a side chain represented by the formula —(O—CF₂CFR_{f})ₐ—O—CF₂CFR′_{f}SO₃H, wherein R_{f} and R′_{f} are independently selected from F, Cl or a perfluorinated alkyl group having 1 to 10 carbon atoms, a=0, 1 or 2. The typical polymers include, for example, polymers disclosed in U.S. Pat. No. 3,282,875 and in U.S. Pat. Nos. 4,358,545 and 4,940,525. One typical polymer comprises a perfluorocarbon backbone and the side chain is represented by the formula —O—CF₂CF(CF₃)—O—CF₂CF₂SO₃H. Polymers of this type are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octene-sulfonyl fluoride) (PDMOF), followed by conversion to sulfonate groups by hydrolysis of the sulfonyl fluoride groups and ion exchanging to convert to the acid, also known as the proton form. One typical polymer of the type disclosed in U.S. Pat. Nos. 4,358,545 and 4,940,525 has the side chain —O—CF₂CF₂SO₃H. This polymer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and acid exchange.

For perfluorinated polymers of the type described above, the ion exchange capacity of a polymer can be expressed in terms of ion exchange ratio (“IXR”). Ion exchange ratio is defined as number of carbon atoms in the polymer backbone in relation to the ion exchange groups. A wide range of IXR values for the polymer is possible. Typically, however, the IXR range for perfluorinated sulfonate polymer is usually about 7 to about 33. For perfluorinated polymers of the type described above, the cation exchange capacity of a polymer is often expressed in terms of equivalent weight (EW). For the purposes of this application, equivalent weight (EW) is defined to be the weight of the polymer in acid form required to neutralize one equivalent of NaOH. In the case of a sulfonate polymer where the polymer comprises a perfluorocarbon backbone and the side chain is —O—CF₂—CF(CF₃)—O—CF₂—CF₂—SO₃H (or a salt thereof), the equivalent weight range which corresponds to an IXR of about 7 to about 33 is about 700 EW to about 2000 EW. A preferred range for IXR for this polymer is about 8 to about 23 (750 to 1500 EW), most preferably about 9 to about 15 (800 to 1100 EW).

The membranes may typically be made by known extrusion or casting techniques and have thicknesses which may vary depending upon the application, and typically have a thickness of 350 μm or less. The trend is to employ membranes that are quite thin, i.e., 50 μm or less. While the polymer may be in alkali metal or ammonium salt form, it is typical for the polymer in the membrane to be in acid form to avoid post treatment acid exchange steps. Suitable perfluorinated sulfonic acid polymer membranes in acid form are available under the trademark Nafion® by E.I. du Pont de Nemours and Company.

Reinforced perfluorinated ion exchange polymer membranes can also be utilized in CCM manufacture. Reinforced membranes may be made by impregnating porous, expanded PTFE (ePTFE) with ion exchange polymer. ePTFE is available under the tradename “Goretex” from W.L. Gore and Associates, Inc., Elkton Md., and under the tradename “Tetratex” from Tetratec, Feasterville Pa. Impregnation of ePTFE with perfluorinated sulfonic acid polymer is disclosed in U.S. Pat. Nos. 5,547,551 and 6,110,333.

Alternately, the ion exchange membrane may be a porous support for the purposes of improving mechanical properties, for decreasing cost and/or other reasons. The porous support may be made from a wide range of components, for e.g., hydrocarbons such as a polyolefin, e.g., polyethylene, polypropylene, polybutylene, copolymers of those materials, and the like. Perhalogenated polymers such as polychlorotrifluoroethylene may also be used. The membrane may also be made from a polybenzimadazole polymer. This membrane may be made by casting a solution of polybenzimadazole in phosphoric acid (H₃PO₄) doped with trifluoroacetic acid (TFA) as described in U.S. Pat. Nos. 5,525,436; 5,716,727, 6,025,085 and 6,099,988.

Process For Synthesis:

In a specific embodiment, the PtXₐAl_{b} (a>0, b>0) precursor may be synthesized in a vapor deposition reactor that consisted of a water-cooled cylindrical stainless steel holder that rotated around its vertical axis. Other known vapor deposition reactors include resistively heated vacuum evaporators, inductively heated vacuum evaporators, electron beam heated vacuum evaporators, secondary ion beam sputtering evaporators, and chemical vapor deposition reactors.

The substrate was fastened onto the holder at a given elevation. Four magnetron sputter vaporization sources, each using several centimeters in diameter target, typically about 5 to about 20 cm in diameter target, and most typically about 5 cm diameter target, may be located around the holder at about 90° from each other and radially faced the cylindrical holder. The elevation “z” of the substrate was defined as z=0. The elevation “z” of the center line of each magnetron sputter vaporization source may be independently controlled and referred to that of the substrate. The position of a magnetron sputter vaporization source located above the substrate was defined by an elevation z>0; the position of a magnetron sputter vaporization source located below the substrate was defined by an elevation z<0.

A PtXₐAl_{b} (a>0, b>0) precursor may be vapor deposited onto a moving substrate, for example a sheet substrate, such as Spectracarb 2050A carbon paper. The substrate was properly masked to yield a set coated surface region, and elemental Pt, X and Al vapors, each emitted from a separate magnetron sputter vaporization source were sequentially deposited by repeated exposure of the substrate to the vapors to form the precursor coating of the required size. Control of the PtXₐAl_{b} stoichiometry may be achieved via independent control of the ignition power fed to each magnetron sputter vaporization source and its elevation relative to that of the substrate. No external substrate heating was exercised during the vapor deposition step. For each synthesis, the vapor deposition system may be pumped down to a pre-synthesis base pressure below about 5·10⁻⁶ Torr, and it may be subsequently back filled with flowing O₂ to a pressure of about 50 mTorr to treat the substrate prior to vapor deposition of the precursor. To execute such substrate treatment, the cylindrical holder may be RF ignited at about 10 to about 500 watts, more typically about 60 to about 300 watts and most typically about 80 watts, for about 1 to about 100 minutes, more typically about 10 minutes. The gas flow may be then switched from flowing O₂ to flowing Ar and the pressure was adjusted to the required pressure to conduct the vapor deposition of the precursor. Synthesis may be done, while the substrate was rotated at about 1 to about 50 rpm, typically about 5 RPM and total co-ignition time for vapor deposition was determined by the thickness of the precursor coating desired, typically about 10 minutes.

Chemical Activation:

In one embodiment the PtXₐAl_{b} precursor coated substrate may be immersed for a set minimum time, typically about 5 minutes, and up to about 120 minutes in a caustic solution such as 20 wt % NaOH solution held at RT, followed by immersion for a set minimum time, typically about 5 minutes, and up to about 120 minutes in a caustic solution such as 20 wt % NaOH solution at an elevated temperature, typically about 80° C. Other useful caustic solutions include potasium hydroxide solutions. Volume of the caustic solution may typically be orders of magnitude larger than that at which caustic would be depleted.

Fuel Cell:

The fuel cell of the invention comprises a coated substrate, wherein the coated substrate comprises a substrate having thereon a catalyst composition, wherein the catalyst composition comprises a catalyst for the electrooxidation of fuels that is prepared by the chemical activation of vapor deposited substantially semicrystalline
PtXₐAl_{b}
wherein X is selected from the group consisting of Ru, W, V, Hf, Rh, Zr, Mo, Nb and Co, and a is at least 0.001, and b is at least 0.85·(1+a); with the proviso that when a=1 and b=8, X is only selected from the group consisting of W, V, Hf, Zr, Nb, and Co. The coated substrate may be a catalyst coated membrane or a coated gas diffusion backing electrode.

Catalysts in the anode and the cathode typically induce the desired electrochemical reactions. The fuel cells typically also comprise a porous, electrically conductive sheet material that is in electrical contact with each of the electrodes, and permits diffusion of the reactants to the electrodes. As described earlier, the catalyst compositions may applied, i.e., vapor deposited, onto an ion exchange membrane, to form an anode or cathode thereon, thereby forming a catalyst coated membrane. Alternatively, the catalyst composition may be applied, i.e., vapor deposited, onto a porous, conductive sheet material, typically known as a gas diffusion backing to form a gas diffusion backing electrode.

An assembly including the membrane, and gas diffusion backings with the catalyst composition applied either on the membrane or the gas diffusion backings or on both, is sometimes referred to as a membrane electrode assembly (“MEA”). Bipolar separator plates, made of a conductive material and providing flow fields for the reactants, are placed between a number of adjacent MEAs. A number of MEAs and bipolar plates are assembled in this manner to provide a fuel cell stack.

For the electrodes to function effectively in these types of fuel cells, effective anode and cathode catalyst sites must be provided. Effective anode catalyst sites have several desirable characteristics: (1) the sites are accessible to the reactant, (2) the sites are electrically connected to the gas diffusion layer, and (3) the sites are ionically connected to the fuel cell electrolyte. Effective cathode catalyst sites have several desirable characteristics: (1) the sites are accessible to the reactant, (2) the sites are electrically connected to the gas diffusion layer, and (3) the sites are ionically connected to the fuel cell electrolyte.

It is desirable to seal reactant fluid stream passages in a fuel cell stack to prevent leaks or inter-mixing of the fuel and oxidant fluid streams. Fuel cell stacks typically employ fluid tight resilient seals, such as elastomeric gaskets between the separator plates and membranes. Such seals typically circumscribe the manifolds and the electrochemically active area. Sealing may be achieved by applying a compressive force to the resilient gasket seals.

Fuel cell stacks are compressed to enhance sealing and electrical contact between the surfaces of the separator plates and the MEAs, and sealing between adjacent fuel cell stack components. In conventional fuel cell stacks, the fuel cell stacks are typically compressed and maintained in their assembled state between a pair of end plates by one or more metal tie rods or tension members. The tie rods typically extend through holes formed in the stack end plates, and have associated nuts or other fastening means to secure them in the stack assembly. The tie rods may be external, that is, not extending through the fuel cell plates and MEAs, however, external tie rods can add significantly to the stack weight and volume. It is generally preferable to use one or more internal tie rods that extend between the stack end plates through openings in the fuel cell plates and MEAs as described in U.S. Pat. No. 5,484,666. Typically resilient members are utilized to cooperate with the tie rods and end plates to urge the two end plates towards each other to compress the fuel cell stack.

The resilient members accommodate changes in stack length caused by, for example, thermal or pressure induced expansion and contraction, and/or deformation. That is, the resilient member expands to maintain a compressive load on the fuel cell assemblies if the thickness of the fuel cell assemblies shrinks. The resilient member may also compress to accommodate increases in the thickness of the fuel cell assemblies. Preferably, the resilient member is selected to provide a substantially uniform compressive force to the fuel cell assemblies, within anticipated expansion and contraction limits for an operating fuel cell. The resilient member may comprise mechanical springs, or a hydraulic or pneumatic piston, or spring plates, or pressure pads, or other resilient compressive devices or mechanisms. For example, one or more spring plates may be layered in the stack. The resilient member cooperates with the tension member to urge the end plates toward each other, thereby applying a compressive load to the fuel cell assemblies and a tensile load to the tension member.

### EXAMPLES

Determination of Eₒₙₛ for MeOH Electrooxidation:

Electrodes having a 1.5 cm² active region were evaluated by linear polarization in a 1M CH₃OH/0.5M H₂SO₄ solution using a 3 electrode system where the counter electrode is a Pt coil and a SCE (saturated electrode) was used as the reference electrode. The potential was scanned from the open circuit potential (E_{oc}) to 0.7V vs SCE. The current was compared at all potentials. Eₒₙₛ for MeOH electrooxidation was defined as the potential at which current for methanol oxidation commences.

Prior to linear polarization testing, the electrode was evaluated for its activity for methanol oxidation by using cyclic voltammetry (CV) in a 1M CH₃OH/0.5M H₂SO₄ solution using a 3 electrode system where the counter electrode was a Pt coil and a SCE was used as the reference electrode. The potential was scanned from the open circuit potential (E_{oc}) to 1.1 V and back to −0.25V at a scan rate of 50 mV/sec.

Electrode Fabrication:

Electrodes containing ink-based catalysts were fabricated by depositing Nafion®/catalyst inks on Spectracarb® 2050A carbon paper covering 1.5 cm².

Electrodes containing experimental catalysts were fabricated by vapor depositing the experimental ternary Pt precursor alloy onto a 1.5 cm² region of the Spectracarb® 2050A carbon papers using the following procedure:

Experimental Catalyst Synthesis:

The PtXₐAl_{b} (a>0, b>0) precursor was synthesized in a vapor deposition reactor that consisted of a water-cooled cylindrical stainless steel holder that rotated around its vertical axis. The Spectracarb® 2050A carbon paper substrate was fastened onto the holder at a given elevation. Four magnetron sputter vaporization sources, each using a 5 cm diameter target, were located around the holder at 90° from each other and radially faced the cylindrical holder. The elevation “z” of the substrate was defined as z=0. The elevation “z” of the center line of each magnetron sputter vaporization source was independently controlled and referred to that of the substrate. The position of a magnetron sputter vaporization source located above the substrate was defined by an elevation z>0; the position of a magnetron sputter vaporization source located below the substrate was defined by an elevation z<0.

A PtXₐAl_{b} (a>0, b>0) precursor was vapor deposited onto a moving 1 cm wide Spectracarb 2050A carbon paper substrate, properly masked to yield a 1.5 cm² coated surface region, by means of the sequential deposition of elemental Pt, X and Al vapors, each emitted from a separate magnetron sputter vaporization source. The rotating substrate was repeatedly exposed to the sequence of the different vapors. Control of the PtXₐAl_{b} stoichiometry was achieved via independent control of the ignition power fed to each magnetron sputter vaporization source and its elevation relative to that of the substrate. No external substrate heating was exercised during the vapor deposition step. For each synthesis, the vapor deposition system was pumped down to a pre-synthesis base pressure below 5·10⁻⁶ Torr, and it was subsequently back filled with flowing O₂ to a pressure of 50 mTorr to treat the substrate prior to vapor deposition of the precursor. To execute such substrate treatment, the cylindrical holder was RF ignited at 80 watts for 10 minutes to generate a glow discharge around the substrate. The gas flow was then switched from flowing O₂ to flowing Ar and the pressure was adjusted at 10 mTorr to conduct the vapor deposition of the precursor. Such synthesis took place on an electrically grounded substrate rotated at 5 RPM and total coignition time for vapor deposition was 10 minutes.

X-ray diffraction analysis of some precursor formulations indicated the existence of amorphous regions within these material as evidenced by the presence of a broad envelope in the 20°-30° scattering direction of the diffractogram. Such evidence is consistent with the expected quenching effect exerted by the water-cooled holder that facilitates amorphization during the synthesis of these aluminide materials.

Subsequently, the Spectracarb 2050A carbon paper, having a 1.5 cm² region coated with the PtXₐAl_{b} precursor, was immersed for a minimum of 5 minutes and up to 120 minutes in a 20 wt % NaOH solution held at RT, followed by immersion for a minimum of 5 minutes and up to 120 minutes in a 20 wt % NaOH solution held at 80° C. Volume of the caustic solution was orders of magnitude larger than that at which caustic would be depleted.

Control 1:

Example 4 of U.S. Pat. No. 5,872,074 was repeated to prepare mechanically alloyed powders having the stoichiometric formula PtRuAl₈ from a mixture of elemental powders of Pt, Ru and Al using a SPEX 8000® grinder consisting of a WC crucible with three WC balls. The weight ratio of the balls to the powders was 4:1. The high energy ball milling operation lasted 40 hours. Particle size distribution analysis, scanning electron microscopy analysis and ICP analysis confirmed the findings claimed in U.S. Pat. No. 5,872,074. The prepared PtRuAl₈ powder was sonically mixed into a Nafion® 990 EW solution to yield an ink having 8 wt % solids in 92 wt % amyl alcohol solvent, with a solid weight ratio of 80% PtRuAl₈ powder and 20 wt % Nafion® 990 EW.

A Spectracarb 2050A carbon paper was painted with such ink to achieve a nominal loading of 0.65 mg_{Pt}/cm² distributed over a 1.5 cm² region. The electrode was then subjected to a caustic activation treatment by immersing it for 15 minutes in a 20 wt % NaOH solution held at RT, followed by immersion in a 20 wt % NaOH solution held at 80° C. for 15 minutes. Upon CV and linear polarization testing such electrode shows a Eₒₙₛ for MeOH electrooxidation of 250 mV versus SCE.

### Example 1

Following the RF oxygen glow discharge treatment of the substrate as detailed in the experimental section above, the precursor was synthesized using the experimental catalyst synthesis procedure described above by coigniting a Pt magnetron sputter vaporization source, located at z=−0.75 cm, at 100 watts; a Ru magnetron sputter vaporization source, located at z=−7.00 cm, at 100 watts; an Al magnetron sputter vaporization source, located at z=−0.75 cm, at 400 watts; and an additional Al magnetron sputter vaporization source, located at z=−7.00 cm, at 400 watts. The so formed semicrystalline precursor was subsequently activated by immersing it for 15 minutes in a 20 wt % NaOH solution held at RT, followed by immersion in a 20 wt % NaOH solution held at 80° C. for 15 minutes. The Spectracarb 2050A carbon paper having thereon a PtRu_{0.020}Al_{3.125} precursor, that was caustic-activated and tested by CV and linear polarization, showed a Eₒₙₛ for MeOH electrooxidation of 187 mV versus SCE.

### Example 2

Example 1 was repeated with the following exceptions: the Pt magnetron sputter vaporization source was located at z=+7.25 cm, at 100 watts, the Ru magnetron sputter vaporization source was located at z=+1.00 cm, at 100 watts, the Al magnetron sputter vaporization source was located at z=+7.25 cm, at 400 watts, and the additional Al magnetron sputter vaporization source was located at z=+1.00 cm, at 400 watts. A Spectracarb 2050A carbon paper having thereon a PtRu_{11.152}Al_{76.435} precursor, that was caustic-activated and tested by CV and linear polarization, showed a Eₒₙₛ for MeOH electrooxidation of 118 mV versus SCE.

### Example 3

Example 1 was repeated with the following exceptions: the Pt magnetron sputter vaporization source was located at z=+2.00 cm, at 100 watts, the W magnetron sputter vaporization source was located at z=0.00 cm, at 100 watts, the Al magnetron sputter vaporization source was located at z=+3.00 cm, at 400 watts, and the additional Al magnetron sputter vaporization source was located at z=−4.00 cm, at 400 watts. A Spectracarb 2050A carbon paper having thereon a PtW_{0.136}Al_{3.45} precursor, that was caustic-activated and tested by CV and linear polarization, showed a Eₒₙₛ for MeOH electrooxidation of 222 mV versus SCE.

### Example 4

Example 1 was repeated with the following exceptions: the Pt magnetron sputter vaporization source was located at z=+1.25 cm, at 100 watts, the V magnetron sputter vaporization source was located at z=−5.00 cm, at 100 watts, the Al magnetron sputter vaporization source was located at z=+1.25 cm, at 400 watts, and the additional Al magnetron sputter vaporization source was located at z=−5.00 cm, at 400 watts. A Spectracarb 2050A carbon paper having thereon a PtV_{0.043}Al_{3.019} precursor, that was caustic-activated and tested by CV and linear polarization, showed a Eₒₙₛ for MeOH electrooxidation of 213 mV versus SCE.

### Example 5

Example 1 was repeated with the following exceptions: the Pt magnetron sputter vaporization source was located at z=−3.75 cm, at 100 watts, the Hf magnetron sputter vaporization source was located at z=−10.00 cm, at 100 watts, the Al magnetron sputter vaporization source was located at z=−3.75 cm, at 400 watts, and the Al magnetron sputter vaporization source was located at z=−10.00 cm, at 400 watts. A Spectracarb 2050A carbon paper having thereon a PtHf_{0.047}Al_{1.619} precursor, which was caustic-activated and tested by CV and linear polarization, showed a Eₒₙₛ for MeOH electrooxidation of 148 mV versus SCE.

### Example 6

Example 1 was repeated with the following exceptions: the Pt magnetron sputter vaporization source was located at z=−1.75 cm, at 100 watts, the Hf magnetron sputter vaporization source was located at z=−8.00 cm, at 100 watts, the Al magnetron sputter vaporization source, located at z=−1.75 cm, at 400 watts, and the additional Al magnetron sputter vaporization source was located at z=−8.00 cm, at 400 watts. A Spectracarb 2050A carbon paper having thereon a PtHf_{0.020}Al_{2.341} precursor, which was caustic-activated and tested by CV and linear polarization, showed a Eₒₙₛ for MeOH electrooxidation of 137 mV versus SCE.

### Example 7

Example 1 was repeated with the following exceptions: the Pt magnetron sputter vaporization source was located at z=+1.25 cm, at 100 watts, the Rh magnetron sputter vaporization source was located at z=−5.00 cm, at 100 watts, the Al magnetron sputter vaporization source was located at z=+1.25 cm, at 400 watts, and the additional Al magnetron sputter vaporization source was located at z=−5.00 cm, at 400 watts. A Spectracarb 2050A carbon paper having thereon a PtRh_{0.019}Al_{0.899} precursor, which was caustic-activated and tested by CV and linear polarization, showed a Eₒₙₛ for MeOH electrooxidation of 8 mV versus SCE.

### Example 8

Example 1 was repeated with the following exceptions: the Pt magnetron sputter vaporization source was located at z=+6.25 cm, at 100 watts, the Rh magnetron sputter vaporization source was located at z=0.00 cm, at 100 watts, the Al magnetron sputter vaporization source, located at z=+6.25 cm, at 400 watts, and the additionalo Al magnetron sputter vaporization source was located at z=0.00 cm, at 400 watts. A Spectracarb 2050A carbon paper having a PtRh_{3.737}Al_{17.865} precursor, which was caustic-activated and tested by CV and linear polarization, showed a Eₒₙₛ for MeOH electrooxidation of 19 mV versus SCE.

### Example 9

Example 1 was repeated with the following exceptions: the Pt magnetron sputter vaporization source was located at z=−3.75 cm, at 100 watts, the Zr magnetron sputter vaporization source was located at z=−10.00 cm, at 100 watts, the Al magnetron sputter vaporization source was located at z=−3.75 cm, at 400 watts, the additional Al magnetron sputter vaporization source was located at z=−10.00 cm, at 400 watts. A Spectracarb 2050A carbon paper having a PtZr_{0.059}Al_{2.669} precursor, which was caustic-activated and tested by CV and linear polarization, showed a Eₒₙₛ for MeOH electrooxidation of 171 mV versus SCE.

### Example 10

Example 1 was repeated with the following exceptions: the Pt magnetron sputter vaporization source was located at z=+8.25 cm, at 100 watts, the Zr magnetron sputter vaporization source was located at z=+2.00 cm, at 100 watts, the Al magnetron sputter vaporization source was located at z=+8.25 cm, at 400 watts, and the additional Al magnetron sputter vaporization source was located at z=+2.00 cm, at 400 watts. A Spectracarb 2050A carbon paper having a PtZr_{16.067}Al_{106.395} precursor, which was caustic-activated and tested by CV and linear polarization, showed a Eₒₙₛ for MeOH electrooxidation of 101 mV versus SCE.

### Example 11

Example 1 was repeated with the following exceptions: the Pt magnetron sputter vaporization source was located at z=−0.75 cm, at 100 watts, the Nb magnetron sputter vaporization source was located at z=−7.00 cm, at 100 watts, the Al magnetron sputter vaporization source was located at z=−0.75 cm, at 400 watts, and the additional Al magnetron sputter vaporization source was located at z=−7.00 cm, at 400 watts. A Spectracarb 2050A carbon paper having thereon a PtNb_{0.002}Al_{2.782} precursor, which was caustic-activated and tested by CV and linear polarization, showed a Eₒₙₛ for MeOH electrooxidation of 163 mV versus SCE.

### Example 12

Example 1 was repeated with the following exceptions: the Pt magnetron sputter vaporization source was located at z=+7.25 cm, at 100 watts, the Nb magnetron sputter vaporization source was located at z=+1.00 cm, at 100 watts, the Al magnetron sputter vaporization source was located at z=+7.25 cm, at 400 watts, and the additional Al magnetron sputter vaporization source was located at z=+1.00 cm, at 400 watts. A Spectracarb 2050A carbon paper having a PtNb_{17.529}Al_{128.515} precursor, which was caustic-activated and tested by CV and linear polarization, showed a Eₒₙₛ for MeOH electrooxidation of 147 mV versus SCE.

### Example 13

Example 1 was repeated with the following exceptions: the Pt magnetron sputter vaporization source was located at z=+10.25 cm, at 100 watts, the Co magnetron sputter vaporization source was located at z=+4.00 cm, at 100 watts, the Al magnetron sputter vaporization source was located at z=+10.25 cm, at 400 watts, and the additional Al magnetron sputter vaporization source was located at z=+4.00 cm, at 400 watts. A Spectracarb 2050A carbon paper having a PtCo_{0.035}Al_{1.161} precursor, which was caustic-activated and tested by CV and linear polarization, showed a Eₒₙₛ for MeOH electrooxidation of 189 mV versus SCE.

### Example 14

Example 1 was repeated with the following exceptions: the Pt magnetron sputter vaporization source was located at z=+2.25 cm, at 100 watts, the Co magnetron sputter vaporization source was located at z=−4.00 cm, at 100 watts, the Al magnetron sputter vaporization source was located at z=+2.25 cm, at 400 watts, and the additional Al magnetron sputter vaporization source was located at z=−4.00 cm, at 400 watts. A Spectracarb 2050A carbon paper having a PtCo_{7.759}Al_{26.181} precursor, which was caustic-activated and tested by CV and linear polarization, showed a Eₒₙₛ for MeOH electrooxidation of 178 mV versus SCE.

### Example 15

A direct methanol fuel cell (DMFC) is assembled using a gas diffusion anode comprising a PtRuAl catalyst of the invention as follows: (a) one 10-mil silicone gasket is placed on the anode graphite block, (b) a gas diffusion anode measuring 25 cm² is placed into the gasketing opening so that it does not overlap the gasket, (c) a cathode catalyst containing N117 membrane is placed onto the gas diffusion anode and the gasket, (d) one 10-mil silicone gasket is placed on the sandwich of materials, (e) an ELAT® gas diffusion backing (manufactured by ETEK, De-Nora North America, Inc., Somerset, N.J.), measuring 25 cm² is placed into the cathode gasket opening so that it does not overlap the gasket and its microporous-gas diffusion layer is in contact with the cathode catalyst layer, (f) a cathode graphite block is placed on the sandwich and the sandwich is enclosed between end plates, and (g) bolts in a diagonal pattern are torqued in increments of 10 in-lbs to a final torque of 36 in-lbs. The fuel cell is expected to produce electricity when it is operated at 80° C. with feeds of methanol/water on the anode and air on the cathode.

1. A catalyst useful in a proton exchange membrane containing fuel cell for the electrooxidation of fuels prepared by the chemical activation of vapor deposited substantially semicrystalline PtXₐAl_{b} onto a substrate, wherein X is selected from the group consisting of Ru, Rh, Mo, W, V, Hf, Zr, Nb and Co, and a is at least 0.001, and b is at least 0.85·(1+a), with the proviso that when a=1 and b=8, X is only selected from the group consisting of W, V, Hf, Zr, Nb, and Co.

2. The catalyst of claim 1 wherein the fuel is an organic fuel and wherein
when X═Ru, a is at least 0.019, and b is at least 3·(1+a),
when X═Rh, a is at least 0.01, and b is at least 0.85·(1+a),
when X═W, a is at least 0.01, and b is at least 2.5·(1+a),
when X═V, a is at least 0.04, and b is at least 2.8·(1+a),
when X═Hf, a is at least 0.019, and b is at least 1.5·(1+a),
when X═Zr, a is at least 0.01, and b is at least 2.3·(1+a),
when X═Nb, a is at least 0.001, and b is at least 2.2·(1+a), and
when X═Co, a is at least 0.03, and b is at least 2.2·(1+a).

3. The catalyst of claim 1 wherein the fuel is methanol and the onset voltage for methanol electrooxidation is less than about 240 mV versus a saturated calomel electrode (SCE).

4. The catalyst of claim 2 wherein the organic fuel is methanol.

5. The catalyst of claim 1 wherein the fuel is hydrogen.

6. The catalyst of claim 1 wherein the substrate is selected from the group consisting of an ion exchange membrane and a gas diffusion backing.

7. The catalyst of claim 6 wherein the ion exchange membrane is the acid form of a perfluorinated sulfonic acid polymer.

8. The catalyst of claim 6 wherein the gas diffusion backing is carbon paper.

9. The catalyst of claim 8 wherein the gas diffusion backing further comprises a film of carbon particles and a fluoropolymer.

10. The catalyst of claim 9 wherein the fluoropolymer is PTFE.

11. A catalyst for an ion exchange membrane containing fuel cell comprising a ternary composition having an onset voltage for methanol electrooxidation of less than about 240 mV versus a saturated calomel electrode (SCE).

12. The catalyst of claim 11 wherein the terniary composition is prepared by the chemical activation of vapor deposited substantially semicrystalline PtXₐAl_{b} wherein X is selected from the group consisting of Ru, Rh, Mo, W, V, Hf, Zr, Nb and Co, and a is at least 0.001, and b is at least 0.85·(1+a), with the proviso that when a=1 and b=8, X is only selected from the group consisting of W, V, Hf, Zr, Nb, and Co.

13. A coated substrate comprising a substrate having applied thereon a catalyst composition, wherein the catalyst composition comprises a catalyst for the electrooxidation of fuels prepared by the chemical activation of vapor deposited substantially semicrystalline
PtXₐAl_{b}
wherein X is selected from the group consisting of Ru, W, V, Hf, Rh, Zr, Mo, Nb and Co, and
a is at least 0.001, and b is at least 0.85·(1+a); with the proviso that when a=1 and b=8, X is only selected from the group consisting of W, V, Hf, Zr, Nb, and Co.

14. The coated substrate of claim 13 wherein the substrate is selected from the group consisting of an ion exchange membrane and a gas diffusion backing.

15. The coated substrate of claim 14 wherein the ion exchange membrane is the acid form of a perfluorinated sulfonic acid polymer.

16. The coated substrate of claim 14 wherein the gas diffusion backing is carbon paper.

17. The coated substrate of claim 16 wherein the gas diffusion backing further comprises a film of carbon particles and a fluoropolymer.

18. The coated substrate of claim 17 wherein the fluoropolymer is PTFE.

19. The coated substrate of claim 13 wherein the fuel is selected from the group consisting of an organic fuel and hydrogen.

20. The coated substrate of claim 19 wherein the organic fuel is methanol.

21. A fuel cell comprising a coated substrate, wherein the coated substrate comprises a substrate having applied thereon a catalyst composition, wherein the catalyst composition comprises a catalyst for the electrooxidation of fuels prepared by the chemical activation of vapor deposited substantially semicrystalline
PtXₐAl_{b}
wherein X is selected from the group consisting of Ru, W, V, Hf, Rh, Zr, Mo, Nb and Co, and
a is at least 0.001, and b is at least 0.85·(1+a); with the proviso that when a=1 and b=8, X is only selected from the group consisting of W, V, Hf, Zr, Nb, and Co.

22. The fuel cell of claim 21 wherein the substrate is selected from the group consisting of an ion exchange membrane and a gas diffusion backing.

23. The fuel cell of claim 22 wherein the ion exchange membrane is the acid form of the perfluorinated sulfonic acid polymer.

24. The fuel cell of claim 22 wherein the gas diffusion backing is carbon paper.

25. The fuel cell of claim 22 wherein the gas diffusion backing further comprises a film of carbon particles and a fluoropolymer.

26. The coated substrate of claim 25 wherein the fluoropolymer is PTFE.
